(19) United States
(12) Patent Application Publication
(10) Pub. No.: US 2022/0046874 A1
(43) Pub. Date: Feb. 17, 2022

(54) MICROGREENS GROW TRAY AND KIT

(71) Applicant: URBAN LEAF TECHNOLOGIES, INC., New York, NY (US)

(72) Inventors: Robert McCormick ELLIOTT, Brooklyn, NY (US); Nathan LITTLEWOOD, New York, NY (US)

(21) Appl. No.: 17/399,687

(22) Filed: Aug. 11, 2021

Related U.S. Application Data
(60) Provisional application No. 63/065,490, filed on Aug. 13, 2020.

(51) Int. Cl. A01G 31/02; A01G 27/00

(52) U.S. Cl. CPC A01G 31/02; A01G 27/008

(57) ABSTRACT

A tray is provided for growing microgreens. The tray has a tray housing defining a fluid reservoir, and the tray has tray walls enclosing the fluid reservoir. The tray further has a tray floor defining a bottom of the fluid reservoir within the tray housing, and substantially parallel internal walls extending substantially vertically from the tray floor within the fluid reservoir. Each internal wall has an internal wall height smaller than a tray wall height of each of the tray walls. Internal reservoir gaps are provided between each end of each internal wall and an adjacent inner surface of a tray wall such that a segment of the tray floor separates each wall of the plurality of internal walls from the plurality of tray walls. Also provided is a kit for growing microgreens including the tray, a mat, and a lid.

### CROSS-REFERENCE TO RELATED APPLICATIONS

This application claims the benefit of U.S. Provisional Application No. 63/065,490, filed on Aug. 13, 2020, the contents of which are incorporated by reference herein.

### FIELD OF THE INVENTION

The present invention relates to a grow tray and kit for growing microgreens.

### BACKGROUND

There are several approaches to passive hydroponic growth of plants, such as microgreens. One such approach is the Kratky method, in which plants being grown are suspended over a reservoir of nutrient-rich water in a net or perforated cup having a typically inert growth medium. In such a method, root tips extend from the cup in which the plants are located into the water in the reservoir. The roots of the plants therefore draw water from the reservoir directly towards the plants. As the plants grow and deplete the water level, a gap of moist air forms and roots begin to draw oxygen from the resulting gap between the growth medium and the water. Once the water is depleted, the plants should be ready to harvest.

Another approach to passive hydroponics is a wick-based system. In a wick-based system, the plants, typically starting as seeds or seedlings, are located in a growing medium and suspended over a fluid reservoir, and a wick formed from any of a large variety of materials extends from the growing medium into the fluid reservoir. The fluid is then drawn to the growing medium as a result of capillary action within the wick.

In passive hydroponic systems, it is difficult to maintain the proper level of moisture and the proper access to oxygen around a growing mat. Kratky systems may allow a mat to dry out during a spouting stage, since roots are not yet present. Wicking systems, on the other hand, may not provide sufficient moisture to a growing mat during a growth stage. Further, in wicking systems, growing mats can become waterlogged if the mats are not properly located relative to a reservoir and if the wicking is not properly controlled.

Most new developments related to growing microgreens have been in the development of quilted composites that generally contain a bottom supporting structure, seeds, and a removable layer to trap in humidity for seed germination. These approaches have used layers formed from coconut fiber and basalt mineral wool, for example.

Large scale microgreen growing systems have been developed that consist of a structural system, horizontal ponds, and floating rafts.

There is a need for systems that allow microgreen growth with little user knowledge, maintenance, and consumable materials. There is a further need for systems that provide an ideal growing environment for both sprouting and growth stages of microgreen development.

### SUMMARY

A tray and kit are provided for growing microgreens.

The tray comprises a tray housing defining a fluid reservoir, the tray comprising a plurality of tray walls enclosing the fluid reservoir. The tray further has a tray floor defining a bottom of the fluid reservoir within the tray housing.

The tray further has a plurality of substantially parallel internal walls extending substantially vertically from the tray floor within the fluid reservoir, each internal wall of the plurality of substantially parallel internal walls having an internal wall height smaller than a tray wall height of each of the tray walls.

A plurality of internal reservoir gaps are provided between each end of each wall of the plurality of internal walls and an adjacent inner surface of a tray wall such that a segment of the tray floor separates each wall of the plurality of internal walls from the plurality of tray walls.

In some embodiments, one of the internal walls has a water fill level indicator. In some embodiments, such a fill level indicator is centrally located within the fluid reservoir. Such an indicator may comprise a fill level segment having a height smaller than the internal wall height.

A kit may be provided for growing microgreens, the kit having a tray and a grow mat having a flexible surface. In some embodiments, the kit further comprises a lid having a lip for resting on a top surface of the tray walls of the tray and a cover surface configured to extend upwards from the top surface of the tray walls and cover the fluid reservoir.

### BRIEF DESCRIPTION OF THE DRAWINGS

FIG. 1 is a perspective view of a grow tray and kit as fully assembled.

FIG. 2 is an exploded view of the components of the grow tray and kit of FIG. 1.

FIG. 3 is a perspective view of a tray in accordance with this disclosure.

FIG. 4 is a top view of the tray of FIG. 3.

FIG. 5 is a sectioned side view of the tray of FIG. 3.

FIG. 6 is a sectioned front view of the tray of FIG. 3.

FIG. 7 is a sectioned front view of the tray of FIG. 3.

FIG. 8 is a bottom view of the tray of FIG. 3.

FIG. 9 is a perspective view of a lid for use with the tray of FIG. 3.

FIG. 10 is a front view of the lid of FIG. 9.

FIG. 11 is a sectioned view of the tray of FIG. 3 and the lid of FIG. 9.

FIG. 12 is a perspective view of the tray of FIG. 3 with a mat partially inserted.

FIG. 13 is a second perspective view of the tray of FIG. 3 with the mat partially inserted.

FIG. 14 is a perspective view of the tray of FIG. 3 filled with water.

FIG. 15 is a perspective view of the tray of FIG. 3 filled with water with the mat partially inserted.

FIG. 16 is a section view of the tray of FIG. 3 filled with water and with the mat inserted.

FIG. 17 is a perspective view of the tray of FIG. 3 with microgreens growing from the mat.

FIG. 18 is a section view of the tray of FIG. 3 with microgreens growing from the mat.

FIG. 19 shows multiple iterations of the tray of FIG. 3 and the lid of FIG. 9 stacked.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

The embodiments shown and described herein are designed to allow for a complete system that allows for quick microgreen growth with little user knowledge, maintenance, and consumable materials. The embodiments described use a hybrid passive hydroponic design that the user typically only must water once per grow. The parts of the design are typically reusable, thereby resulting in minimal waste generated per grow.

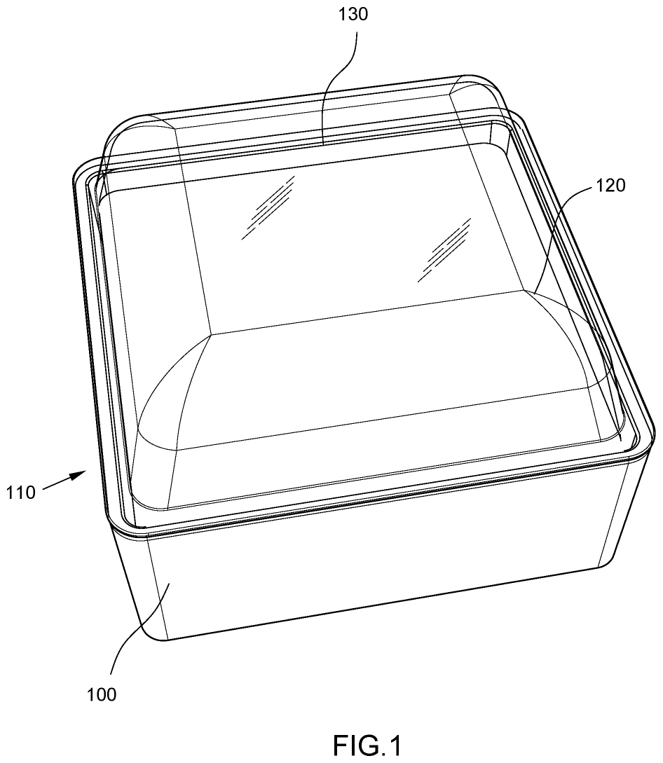

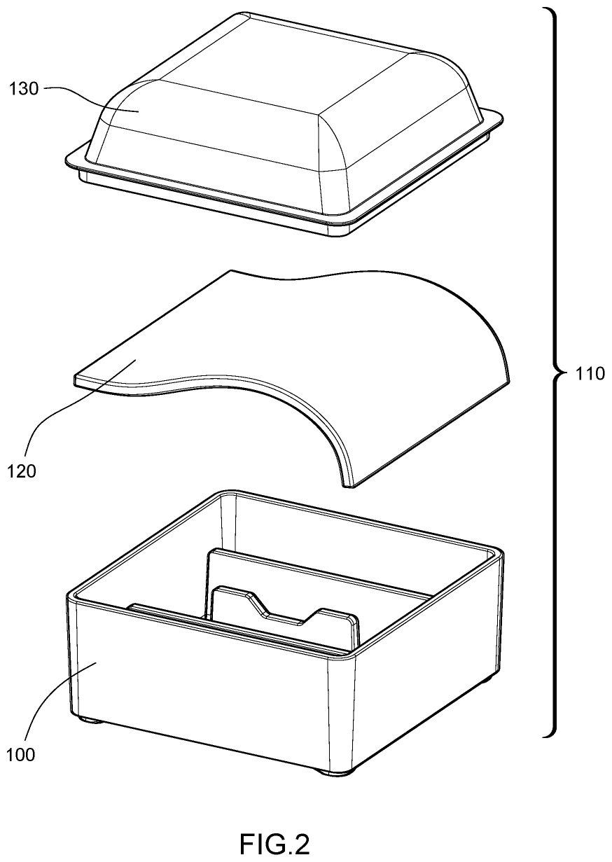

FIG. 1 is a perspective view of a grow tray 100 and kit 110 as fully assembled. FIG. 2 is an exploded view of the components of the kit 110 of FIG. 1. As shown, the kit 110 for growing microgreens typically has a tray 100, a grow mat 120, and a lid 130 which work in concert to provide a complete growing ecosystem.

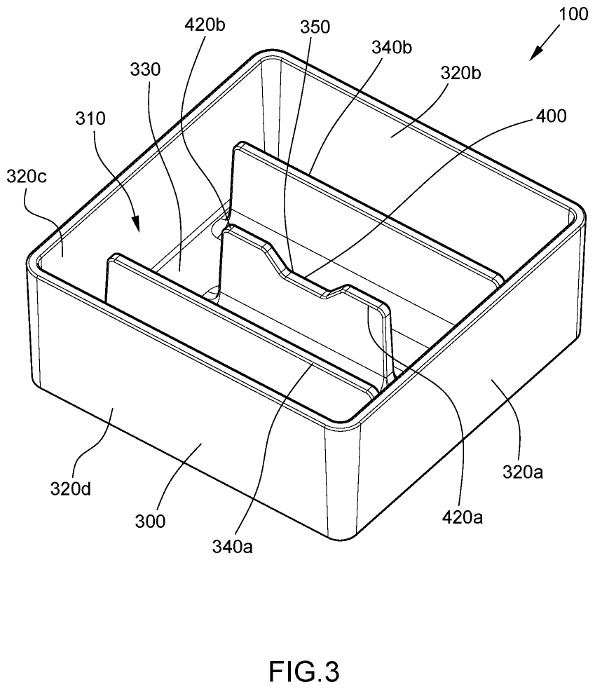

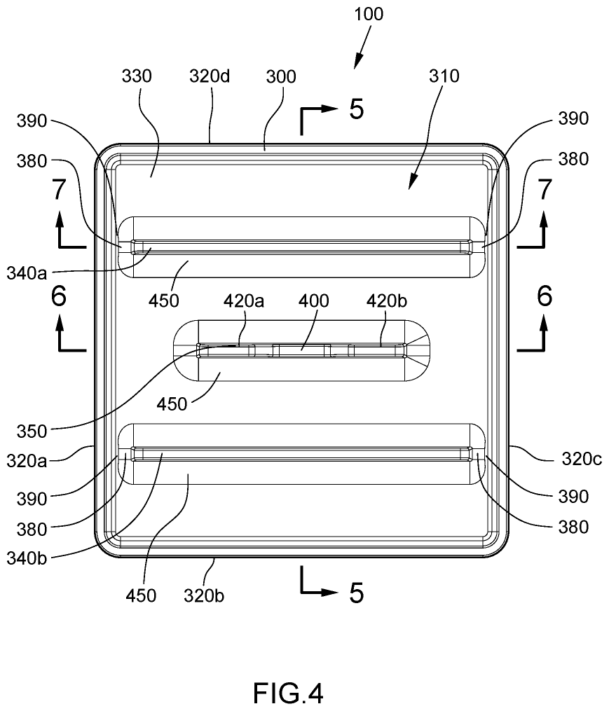

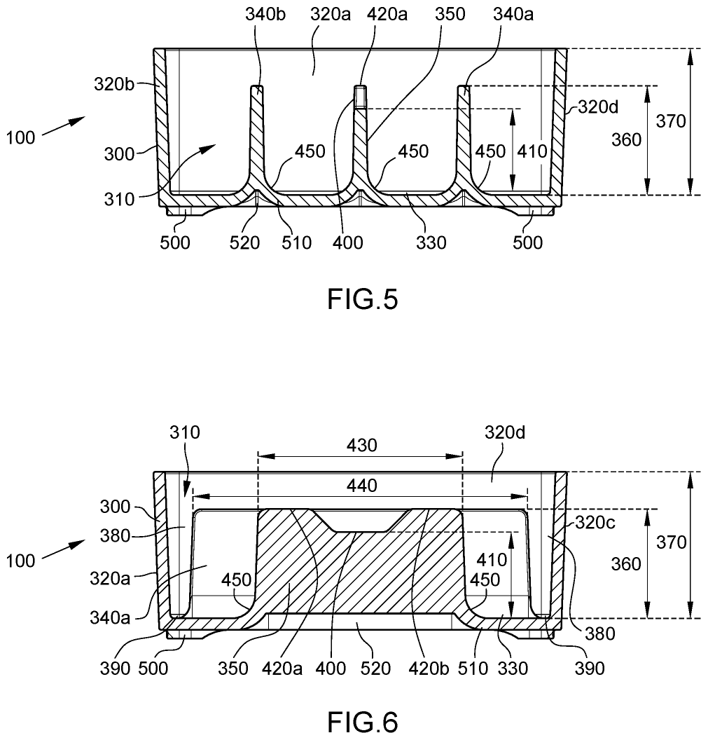

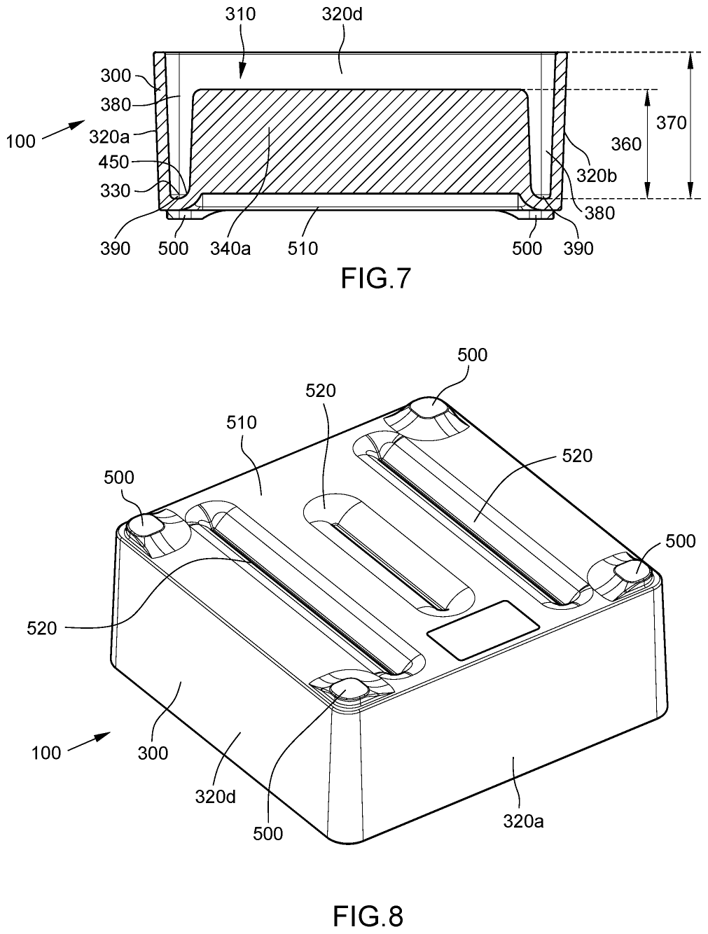

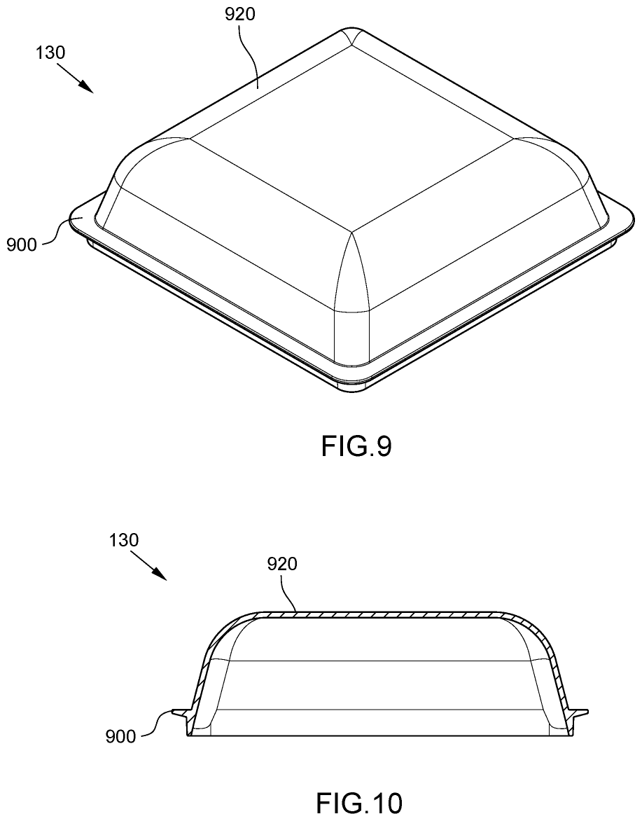

FIG. 3 is a perspective view of a tray 100 in accordance with this disclosure. FIG. 4 is a top view of the tray 100 of FIG. 3. FIGS. 5-7 are sectioned views of the tray 100, and FIG. 8 is a bottom view of the tray of FIG. 3.

As shown, the tray 100 is provided for growing microgreens and comprises a tray housing 300 defining a fluid reservoir 310. The tray 100 has a plurality of tray walls 320a-d enclosing the fluid reservoir 310. The tray 100 further comprises a tray floor 330 defining a bottom of the fluid reservoir 310 within the tray housing 300.

The tray 100 further comprises a plurality of substantially parallel internal walls 340a, b, 350 extending substantially vertically from the tray floor 330 within the fluid reservoir 310, where each of the internal walls has an internal height 360 smaller than a tray wall height 370 of each of the tray walls 320a-d.

The tray 100 also has a plurality of internal reservoir gaps 380 between each end of each wall 340a, b, 350 of the internal walls and an adjacent inner surface of a tray wall 320a, c, such that a segment 390 of the tray floor 330 separates each of the internal walls from the corresponding tray wall.

As shown, one of the internal walls 350 includes a water fill level indicator 400. The water fill level indicator can take many forms, and is typically substantially centrally located within the fluid reservoir 310. In the embodiment shown, the water fill level indicator 400 is a fill level segment in one of the internal walls 350 having a height 410 smaller than the internal wall height 360.

Accordingly, where the water fill level indicator 400 is centrally located, the corresponding internal wall 350 includes at least two full height segments 420a, b equal to the internal wall height 360, and the fill level indicator is then located between the at least two full height segments.

In order to locate the water fill level indicator 400 substantially centrally within the fluid reservoir 310, the tray 100 would typically include an odd number of internal walls 340a, b, 350. In the embodiment shown, three such walls are provided. The wall 350 containing the water fill level indicator 400 would then be a center wall of the internal walls, and would therefore be located between the remaining walls 340a, b.

In some embodiments, such as that shown, the center wall 350 containing the water fill level indicator 400 has a length 430 smaller than a length of the other internal walls 340a, b.

In some embodiments, the tray walls 320a-d are transparent or partially transparent, so that a water level within the fluid reservoir 310 can be seen and, in some such embodiments, compared to the water fill level indicator 400 without removing a lid 130 or removing the grow mat 120. The tray walls 320a-d may be, for example, a brown color that blocks photosynthetic light, but still allows a user to see in to the reservoir 310.

As shown, each of the internal walls 340a, b, 350 extends vertically from the tray floor 330. A transition 450 from the tray floor 330 to each of the internal walls 340a, b, 350 may be arcuate, thereby providing a flared base at the bottom each internal wall and a wide radius. This configuration avoids sharp corners, and results in a transition easier to clean between grows, and therefore more useful for repeated uses.

The tray 100 may further comprise feet 500. Such feet may suspend a bottom surface 510 of the tray 100 above any surface that the tray 100 might be resting on, and may thereby prevent liquid from being trapped under the tray. Accordingly, any water spilled while filling the reservoir 310 would not be trapped under the tray 100. The tray may further comprise depressions 520 on the bottom surface 510 corresponding to the locations of the internal walls 340a, b, 350. Such depressions may allow the tray 100 to be formed from less material while also, in some embodiments, allowing the trays 100 to nest in a more stable and compact configuration.

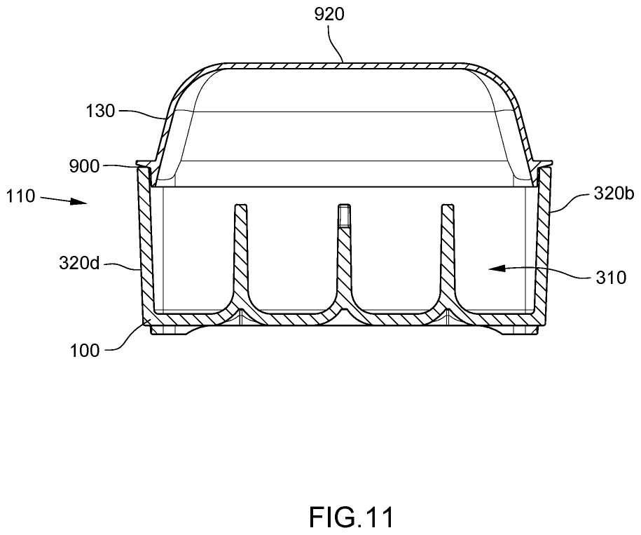

FIG. 9 is a perspective view of a lid 130 for use with the tray 100 of FIG. 3. FIG. 10 is a front view of the lid 130 of FIG. 9. FIG. 11 is a sectioned view of the tray 100 and lid 130 assembled. As shown, the lit 130 has a lip 900 for resting on a top surface 910 of the tray walls 320a-d. The lid 130 also has a cover surface 920 that extends upwards from the top surface 910 of the tray walls 320a-d and covers the fluid reservoir 310.

When applied, the lid 130 may form a sealed environment, thereby maintaining a high level of humidity within the kit 110.

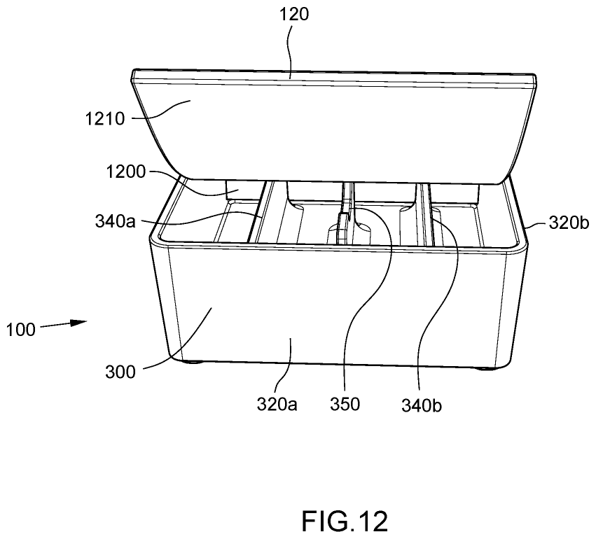

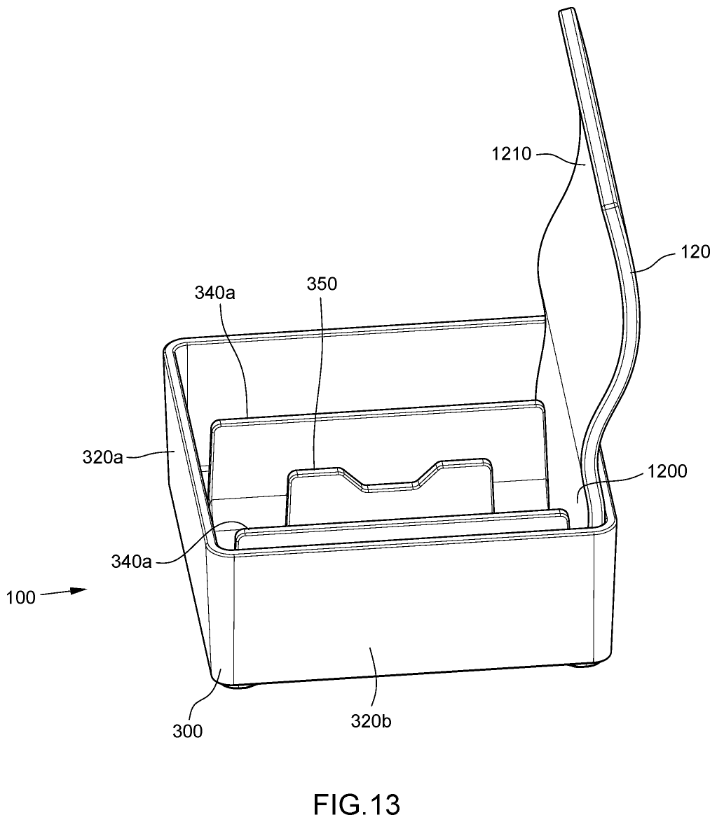

FIGS. 12 and 13 are perspective views of the tray 100 of FIG. 3 with a mat 120 partially inserted. As shown, the mat 120 has a flexible surface, and at least a first portion 1200 of the flexible surface is positioned to extend into the internal reservoir gaps 380, while at least a second portion 1210 of the flexible surface of the mat rests on top of the plurality of substantially parallel internal walls 340a, b, 350.

By positioning the mat 120 such that the first portion 1200 of the flexible surface extends into the gaps 380, that portion of the mat 120 can function as a wick for drawing water from the reservoir 310 into the mat as a whole. The second portion 120 can then rest on top of the internal walls 340a, b, 350 such that roots of seedlings growing out of the mat can extend downwards into the reservoir. The wicking action from the first portion 1200 of the mat 120 keeps the seedlings hydrated before they develop roots long enough to tap directly into any water in the reservoir 310 below them.

By providing multiple internal walls 340a, b, 350, the second portion 1210 of the mat 120 is evenly supported as the seedlings grow, and the gap 380 is sized so as to retain the first portion 1200 of the mat 120 in place. This allows the tray 100 to hold the mat 120 in place even if the tray is jostled while locating or moving the tray.

As shown, where the middle internal wall 350 is smaller in length than the other internal walls 240a, b, the middle wall may not be involved in retaining the first portion 1200 of the mat 120 but may still be involved in supporting the second portion 1210 of the mat.

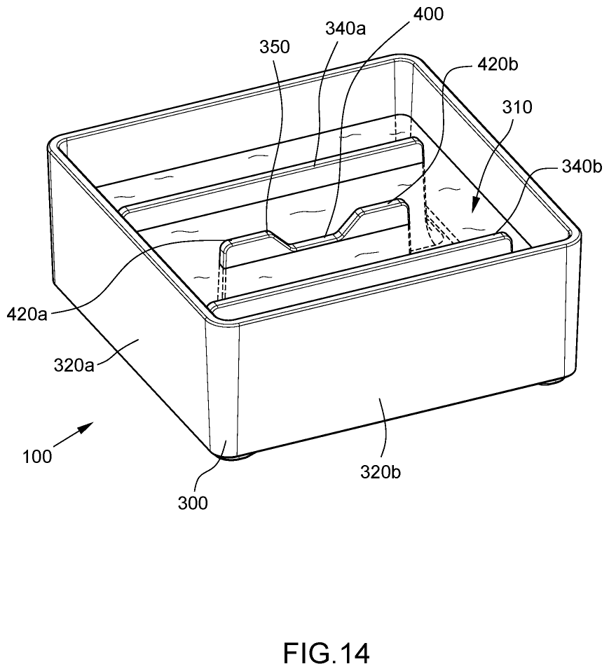

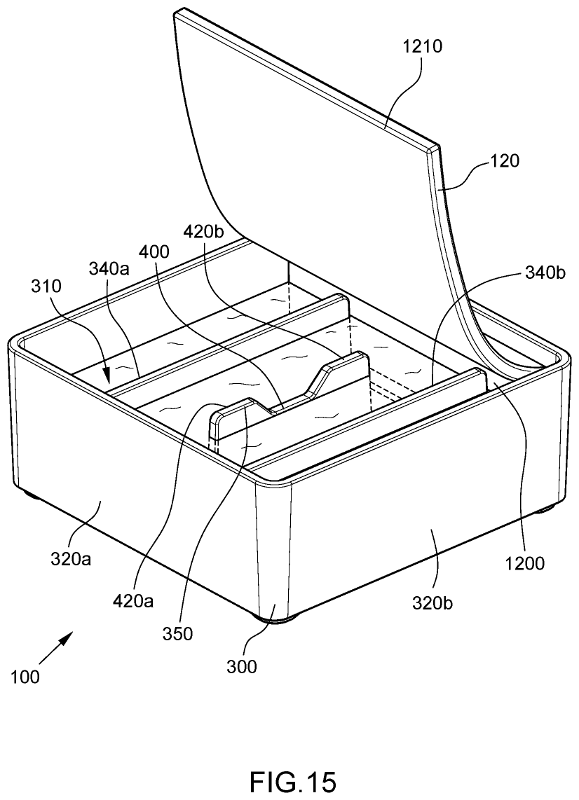

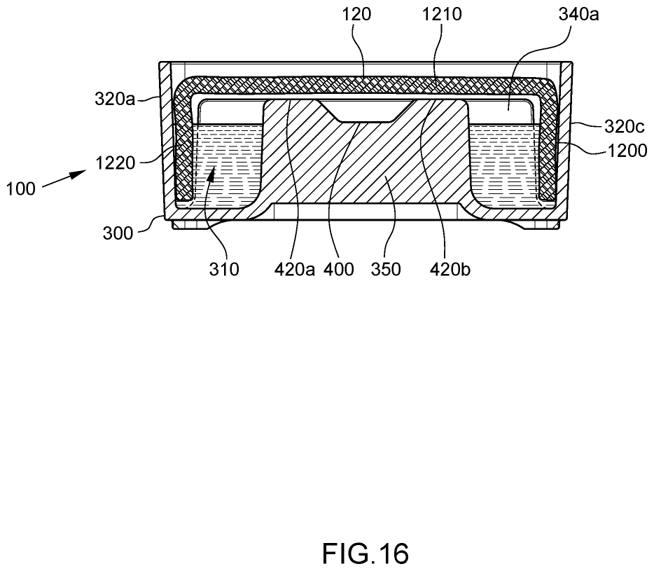

FIG. 14 is a perspective view of the tray 100 of FIG. 3 filled with water. FIG. 15 is a perspective view of the tray 100 of FIG. 3 filled with water with the mat 120 partially inserted. FIG. 16 is a section view of the tray 100 of FIG. 3 filled with water and with the mat 120 inserted. As shown, when determining an appropriate water level to begin a grow process, the reservoir 310 is filled with water up to the water fill level indicator 400.

In order to assess the water level, a user would then hold the tray 100 level, or place the tray on a level surface and compare the water level to the height 410 of the indicator 400. By locating the water fill level indicator 400 centrally within the reservoir 310, the user can accurately measure the water level within the reservoir even if the tray 100 is not held completely level.

As shown, when filled with water, there is a gap 1400 between the water level and the top surfaces of the full height sections of the internal walls 340a, b, 350. As such, when the second portion 1210 of the mat 120 rests upon those top surfaces, as shown in FIG. 16, there is a gap between the water level and the bottom surface of the mat 120. Because of this gap, the first portion 1200 of the mat 120 allows for wicking action to moisten the mat as a whole before roots emerge downwards from the mat. As such, while the mat 120 is moistened by wicking by way of the first portions 1200, the mat is separated from the water level and thereby does not become waterlogged.

As shown, the mat 120 may further comprise a third portion 1220 which is then inserted into gaps 380 between the internal walls 340a, b, and the tray walls 320a-d opposite the first portion 1200. This third portion allows the mat 120 to be located in the tray more securely while moistening the mat as a whole more evenly. It will be understood that in some embodiments, a third portion 1220 is not provided, and the first portion 1200 functions as a wicking element for the mat 120 as a whole.

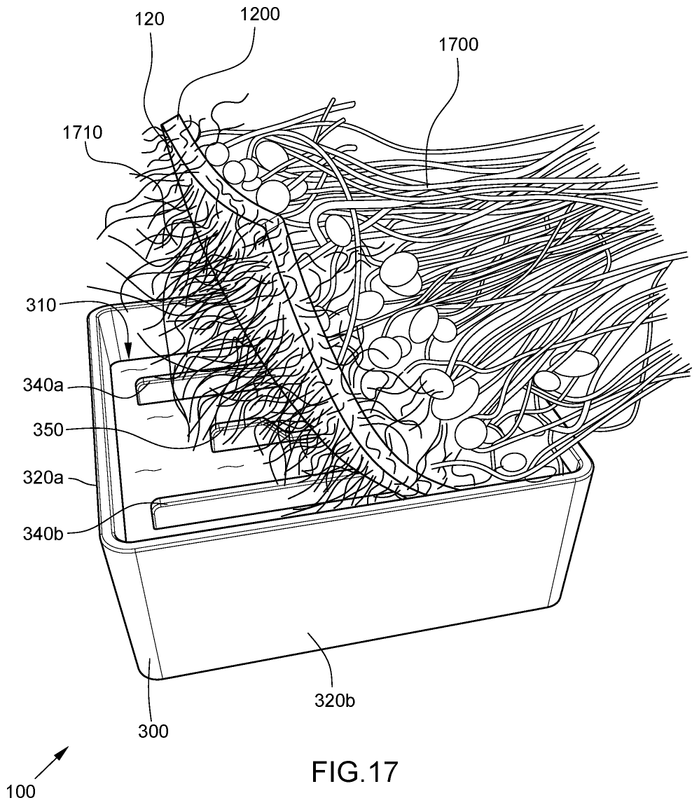

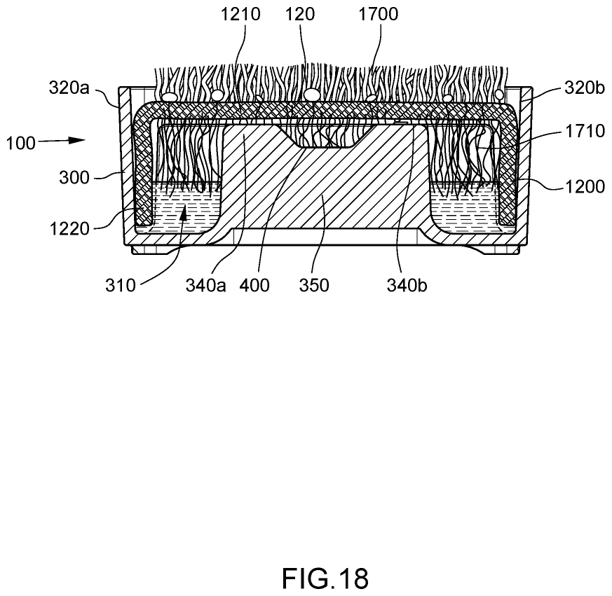

FIG. 17 is a perspective view of the tray 100 of FIG. 3 with microgreens 1700 growing from the mat 120. FIG. 18 is a section view of the tray 100 with microgreens 1700 growing from the mat 120. As shown, once roots 1710 extend downwards from the mat 120, they extend into water contained in the reservoir 310. The roots 1710 then extend between the internal walls 340a, b and draw water directly into the microgreens 1700 being grown.

In this manner, the growth of microgreens 1700 in the tray 100 begins by way of a wicking method, relying on the first portion 1200 of the grow mat 120 as a wick. Once sufficient root growth has begun, the microgreens transition to Kratky method based growth for the duration of their growth.

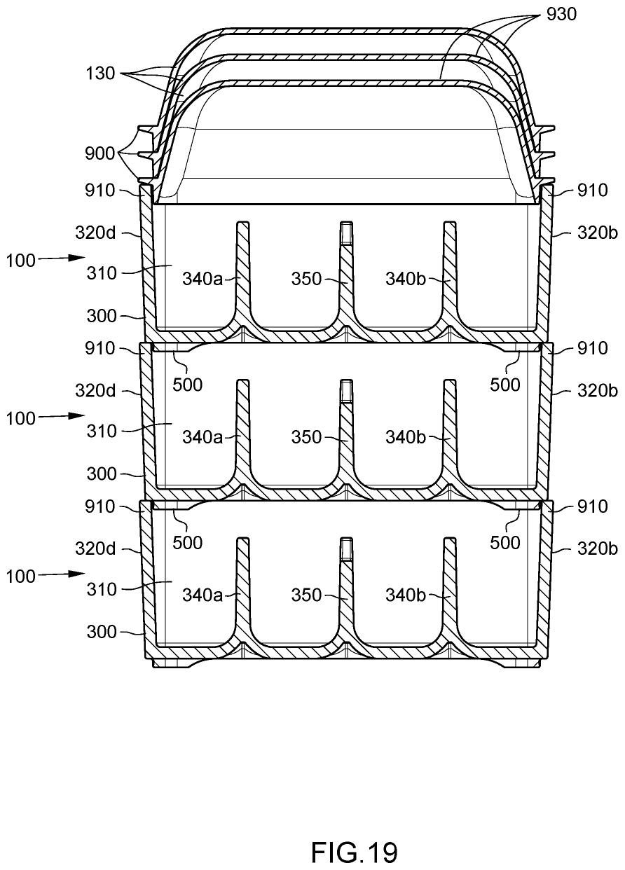

FIG. 19 shows multiple iterations of the tray 100 of FIG. 3 and the lid 130 of FIG. 9 stacked. As shown, the tray 100 is configured to stack with additional instances of identical trays, and the lid 130 is configured to nest with additional instances of identical lids. As a result, the kits 110 taken together are stackable.

As noted above, in some embodiments, depressions 520 are provided on the bottom surface 510 of the tray 100 corresponding to the locations of the internal walls 340a, b, 350. Such depressions may allow the trays 100 to stack more closely than shown by nesting a top of each of the internal walls 340a, b, 350 into a corresponding depression 520 on an adjacent tray 100.

As further shown, the feet 500 on the bottom surface 510 each tray may be inset slightly from an outer wall of the tray housing 300. In some embodiments, such as that shown, this allows the feet 500 of each tray 100 to rest within the reservoir 310 of a tray on which it rests such that an outside surface of each foot is adjacent to a top of the corresponding tray wall 120a-d of the tray housing 300. In this way, the trays 100 can be prevented from sliding relative to each other when stacked, and where the bottom surface 510 of each tray is designed to rest on the top surfaces 910 of the tray walls 120a-d, such bottom surface can be prevented from sliding off of the walls.

In some embodiments, the tray 100 and kit 110 as a whole may be sized such that they can fit on windowsills. As such, they may be provided with a footprint of 10 cm with 10 cm. Further, the kit may be sold with seeds as consumer packaged goods.

Further, although shown as a square, the tray may be provided in additional sizes and shapes. In some embodiments, the tray 100 may be provided as a rectangle, with one side being longer than the others. In such embodiments, the internal walls may be configured as parallel walls and may either extend along the longer dimension of the rectangle, or they may extend along the shorter dimension. When extending along the shorter dimension, the number of internal walls may be increased so as to provide more even support for a longer grow mat.

However, in such embodiments, not all internal walls need be configured to provide the same gap between the internal wall and the tray wall. For example, where more than three walls are provided, such as five walls, only two walls may be configured to provide the required gaps, and two such gaps may be sufficient to securely locate even a longer grow mat. As such, while a water fill level indicator 400 may be provided in only one wall, other walls may have dimensions matching the middle wall 350 rather than the two longer walls 340a, b.

Components of the embodiments shown may be formed from plastic and may be injection molded, or may instead be formed from other materials, such as glass, metal, or ceramic.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A tray for growing microgreens comprising:
a tray housing defining a fluid reservoir, the tray comprising a plurality of tray walls enclosing the fluid reservoir;
a tray floor defining a bottom of the fluid reservoir within the tray housing;
a plurality of substantially parallel internal walls extending substantially vertically from the tray floor within the fluid reservoir, each internal wall of the plurality of substantially parallel internal walls having an internal wall height smaller than a tray wall height of each of the tray walls;
a plurality of internal reservoir gaps between each end of each wall of the plurality of internal walls and an adjacent inner surface of a tray wall such that a segment of the tray floor separates each wall of the plurality of internal walls from the plurality of tray walls.

2. The tray of claim 1 wherein one of the plurality of substantially parallel internal walls has a water fill level indicator.

3. The tray of claim 2 wherein the water fill level indicator is substantially centrally located within the fluid reservoir.

4. The tray of claim 3 wherein the water fill level indicator comprises a fill level segment of the corresponding internal wall having a height smaller than the internal wall height.

5. The tray of claim 4 wherein the internal wall containing the water fill level indicator comprises at least two full height segments having segment heights equal to the internal wall height and wherein the fill level segment of the wall is located between the at least two full height segments.

6. The tray of claim 2 wherein the plurality of substantially parallel internal walls comprises an odd number of internal walls, and wherein the water fill level indicator is in a center wall of the internal walls.

7. The tray of claim 6 wherein the center wall of the internal walls has a length smaller than the other internal walls.

8. The tray of claim 1 further comprising a lid having a lip for resting on a top surface of the tray walls and a cover surface configured to extend upwards from the top surface of the tray walls and cover the fluid reservoir.

9. The tray of claim 1 further comprising a grow mat having a flexible surface, wherein at least one portion of the flexible surface extends into the internal reservoir gaps and wherein at least one portion of the flexible surface rests on top of the plurality of substantially parallel internal walls.

10. The tray of claim 1, wherein each of the internal walls extends vertically from the tray floor, and wherein a transition from the tray floor to each internal wall is arcuate.

11. The tray of claim 1 wherein the plurality of tray walls are at least partially transparent.

12. A kit for growing microgreens comprising:
a tray having a tray housing defining a fluid reservoir; and
a grow mat having a flexible surface,
the tray comprising a plurality of tray walls enclosing the fluid reservoir, a tray floor defining a bottom of the fluid reservoir, and a plurality of substantially parallel internal walls,
wherein each of the substantially parallel internal walls has an internal wall height smaller than a tray wall height of each of the tray walls;
wherein each of the internal walls extends across an internal dimension of the tray and has a length smaller than the corresponding internal dimension, such that there is a space between each end of each of the internal walls and an adjacent tray wall of the plurality of tray walls.

13. The kit of claim 12, wherein a segment of the tray floor separates each wall of the plurality of internal walls from the corresponding adjacent tray wall.

14. The kit of claim 12 further comprising a lid having a lip for resting on a top surface of the tray walls and a cover surface configured to extend upwards from the top surface of the tray walls and cover the fluid reservoir.

15. The kit of claim 14 wherein the tray is configured to stack with additional instances of an identical tray, and wherein the lid is configured to nest with additional instances of an identical lid, such that the trays and lids are stackable.

16. The kit of claim 12 wherein one of the plurality of substantially parallel internal walls has a water fill level indicator.

17. The kit of claim 16 wherein the water fill level indicator is substantially centrally located within the fluid reservoir.

18. The kit of claim 17 wherein the water fill level indicator comprises a fill level segment of the corresponding internal wall having a height smaller than the internal wall height.

19. The kit of claim 12 wherein the spaces between each end of each of the internal walls and the adjacent tray walls are sized to accommodate at least one end of the grow mat.

20. The kit of claim 12 wherein each of the internal walls extends vertically from the tray floor, and wherein a transition from the tray floor to each internal wall is arcuate.
